(19) United States
(12) Patent Application Publication
(10) Pub. No.: US 2014/0176802 A1
(43) Pub. Date: Jun. 26, 2014

(54) DETECTION AND MEASUREMENT OF VIDEO SCENE TRANSITIONS

(71) Applicant: NVIDIA CORPORATION, Santa Clara, CA (US)

(72) Inventors: XINYANG YU, Qitaihe (CN); Rirong CHEN, Shanghai (CN); Yinyuan HU, Shanghai (CN); Xi HE, Shanghai (CN); Jincheng LI, Shanghai (CN); Jianjun CHEN, Shanghai (CN)

(73) Assignee: NVIDIA CORPORATION, Santa Clara, CA (US)

(21) Appl. No.: 13/725,072

(22) Filed: Dec. 21, 2012

(51) Int. Cl. H04N 5/14

(52) U.S. Cl. CPC H04N 5/147
USPC 348/700

(57) ABSTRACT

One embodiment of the present invention sets forth a technique for detecting a video transition. The technique involves calculating a first average pixel intensity for each pixel grouping included in a first plurality of pixel groupings, calculating a second average pixel intensity for each pixel grouping included in a second plurality of pixel groupings, and calculating a third average pixel intensity for each pixel grouping included in a third plurality of pixel groupings. The technique further involves comparing a first average pixel intensity to a corresponding second average pixel intensity to identify a first trend, comparing a second average pixel intensity to a corresponding third average pixel intensity to identify a second trend, and comparing the first trend to the second trend to determine whether a match exits. Finally, the technique involves determining that a video transition is occurring based on a number of matches.

### BACKGROUND OF THE INVENTION

1. Field of the Invention

The present invention generally relates to image processing, and, more specifically, to a method and system for detecting and measuring video scene transitions in a video stream.

2. Description of the Related Art

Many common video codecs (e.g., H.264, H.265, VC-1, etc.) include the ability to compress video data by dividing a video frame into a plurality of pixel blocks and comparing pixel blocks in consecutive video frames to identify and remove redundant frame data. For example, a video stream which includes static regions (e.g., backgrounds, solid colors, static images, etc.) may be compressed by identifying one or more pixel blocks which are substantially constant between consecutive video frames and applying an algorithm to remove data that is redundant across the video frames.

Additionally, video codecs may include the ability to further compress a video stream by compensating for the motion of the camera and/or the motion of an object between video frames. Such compression techniques are useful, for example, when the position, but not the appearance, of an object changes between consecutive video frames. Furthermore, such compression techniques may be applied to video frames which include video editing effects, such a scene transitions. Video scene transitions generally may be divided into two categories: abrupt transitions and gradual transitions. Gradual transitions include camera movements, such as panning, tilting, zooming, and video editing effects. Video editing special effects may include fade in, fade out, dissolving, and wiping. In particular, fade in and fade out transitions are commonly used in present day movies and television programs.

Conventional techniques for detecting video scene transitions construct and analyze histograms associated with each video frame to determine whether a scene transition is taking place. As a result, conventional techniques are cumbersome, typically requiring entire video frames to be sampled to construct histograms. In addition, conventional techniques may require analysis of an entire scene transition, from beginning to end, for accurate detection of the scene transition. Finally, techniques which utilize histograms are highly susceptible to image noise.

Accordingly, what is needed in the art is an approach that enables more efficient detection of video scene transitions.

### SUMMARY OF THE INVENTION

One embodiment of the present invention sets forth a method for detecting a video transition. The method involves calculating a first average pixel intensity for each pixel grouping included in a first plurality of pixel groupings fetched from a plurality of locations in a first video frame. The method further involves calculating a second average pixel intensity for each pixel grouping included in a second plurality of pixel groupings fetched from the plurality of locations in a second video frame. The method further involves calculating a third average pixel intensity for each pixel grouping included in a third plurality of pixel groupings fetched from the plurality of locations in a third video frame. The method further involves, for each location in the plurality of locations, comparing the first average pixel intensity to the corresponding second average pixel intensity to identify a first trend, comparing the second average pixel intensity to the corresponding third average pixel intensity to identify a second trend, and comparing the first trend to the second trend to determine whether a match exits. Finally, the method involves determining that a video transition is occurring based on a number of matches across the plurality of locations.

Further embodiments provide a non-transitory computer-readable medium and a computing device to carry out the method set forth above.

One advantage of the disclosed technique is that scene transitions may be detected and measured, and their parameters provided to a video codec, in order to improve indexing, retrieval, and compression efficiency. Additionally, by analyzing only portions (e.g., pixel groupings) of each video frame, and not entire video frames, the processing requirements associated with video stream encoding may be reduced.

### BRIEF DESCRIPTION OF THE DRAWINGS

So that the manner in which the above recited features of the invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram illustrating a computer system configured to implement one or more aspects of the present invention;

FIG. 2 illustrates a parallel processing subsystem, according to one embodiment of the present invention;

FIG. 3 illustrates a sequence of pixel blocks during a fade out scene transition, according to one embodiment of the present invention;

FIG. 4 is a flow diagram of methods steps for detecting and measuring a video scene transition, according to one embodiment of the present invention;

FIG. 5 illustrates a flow diagram of method steps for preparing video frame data, according to one embodiment of the present invention;

FIG. 6 illustrates a flow diagram of method steps for determining a trend of a plurality of pixel groupings, according to one embodiment of the present invention; and

FIG. 7 illustrates a flow diagram of method steps for confirming that a scene transition is occurring and/or determining a type of scene transition that is occurring, according to one embodiment of the present invention.

### DETAILED DESCRIPTION

In the following description, numerous specific details are set forth to provide a more thorough understanding of the present invention. However, it will be apparent to one of skill in the art that the present invention may be practiced without one or more of these specific details.

### System Overview

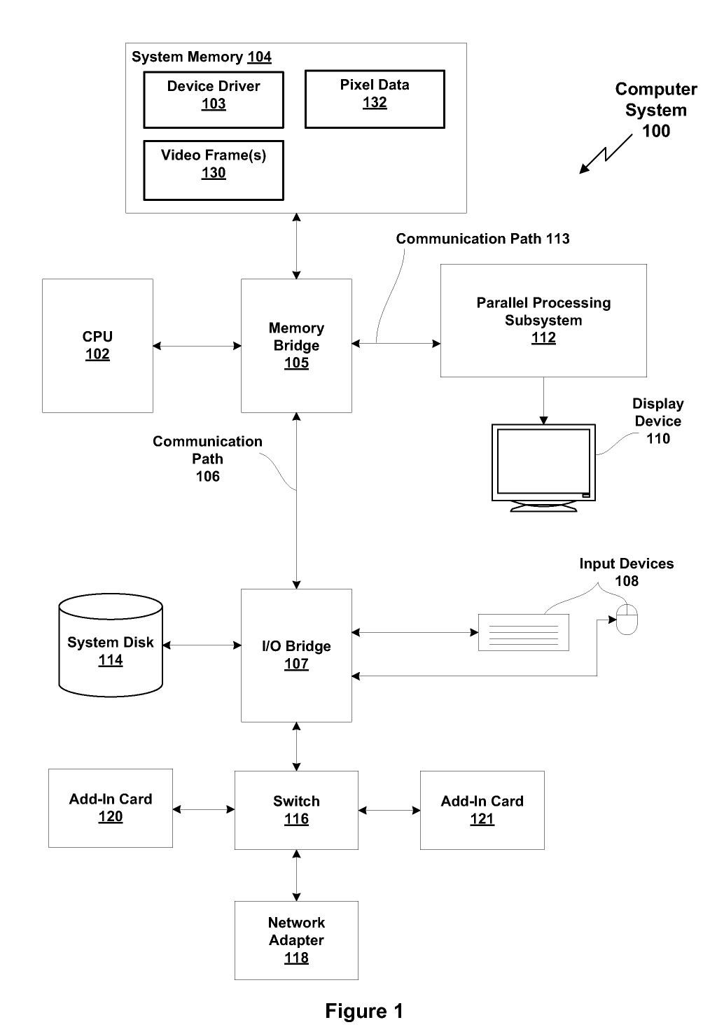

FIG. 1 is a block diagram illustrating a computer system 100 configured to implement one or more aspects of the present invention. Computer system 100 includes a central processing unit (CPU) 102 and a system memory 104 communicating via an interconnection path that may include a memory bridge 105. The system memory 104 may be configured to store a device driver 103, one or more video frames 130, and pixel data 132. The CPU 102 may be configured to execute the displacement map engine 130 to process a normal map 132 and generate a displacement map 134. Memory bridge 105, which may be, e.g., a Northbridge chip, is connected via a bus or other communication path 106 (e.g., a HyperTransport link) to an I/O (input/output) bridge 107. I/O bridge 107, which may be, e.g., a Southbridge chip, receives user input from one or more user input devices 108 (e.g., keyboard, mouse) and forwards the input to CPU 102 via communication path 106 and memory bridge 105. A parallel processing subsystem 112 is coupled to memory bridge 105 via a bus or second communication path 113 (e.g., a Peripheral Component Interconnect (PCI) Express, Accelerated Graphics Port, or HyperTransport link); in one embodiment parallel processing subsystem 112 is a graphics subsystem that delivers pixels to a display device 110 that may be any conventional cathode ray tube, liquid crystal display, light-emitting diode display, or the like. A system disk 114 is also connected to I/O bridge 107 and may be configured to store content and applications and data for use by CPU 102 and parallel processing subsystem 112. System disk 114 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high definition DVD), or other magnetic, optical, or solid state storage devices.

A switch 116 provides connections between I/O bridge 107 and other components such as a network adapter 118 and various add-in cards 120 and 121. Other components (not explicitly shown), including universal serial bus (USB) or other port connections, compact disc (CD) drives, digital versatile disc (DVD) drives, film recording devices, and the like, may also be connected to I/O bridge 107. The various communication paths shown in FIG. 1, including the specifically named communication paths 106 and 113 may be implemented using any suitable protocols, such as PCI Express, AGP (Accelerated Graphics Port), HyperTransport, or any other bus or point-to-point communication protocol(s), and connections between different devices may use different protocols as is known in the art.

In one embodiment, the parallel processing subsystem 112 incorporates circuitry optimized for graphics and video processing, including, for example, video output circuitry, and constitutes a graphics processing unit (GPU). In another embodiment, the parallel processing subsystem 112 incorporates circuitry optimized for general purpose processing, while preserving the underlying computational architecture, described in greater detail herein. In yet another embodiment, the parallel processing subsystem 112 may be integrated with one or more other system elements in a single subsystem, such as joining the memory bridge 105, CPU 102, and I/O bridge 107 to form a system-on-chip (SoC).

It will be appreciated that the system shown herein is illustrative and that variations and modifications are possible. The connection topology, including the number and arrangement of bridges, the number of CPUs 102, and the number of parallel processing subsystems 112, may be modified as desired. For instance, in some embodiments, system memory 104 is connected to CPU 102 directly rather than through a bridge, and other devices communicate with system memory 104 via memory bridge 105 and CPU 102. In other alternative topologies, parallel processing subsystem 112 is connected to I/O bridge 107 or directly to CPU 102, rather than to memory bridge 105. In still other embodiments, I/O bridge 107 and memory bridge 105 might be integrated into a single chip instead of existing as one or more discrete devices. Large embodiments may include two or more CPUs 102 and two or more parallel processing subsystems 112. The particular components shown herein are optional; for instance, any number of add-in cards or peripheral devices might be supported. In some embodiments, switch 116 is eliminated, and network adapter 118 and add-in cards 120, 121 connect directly to I/O bridge 107.

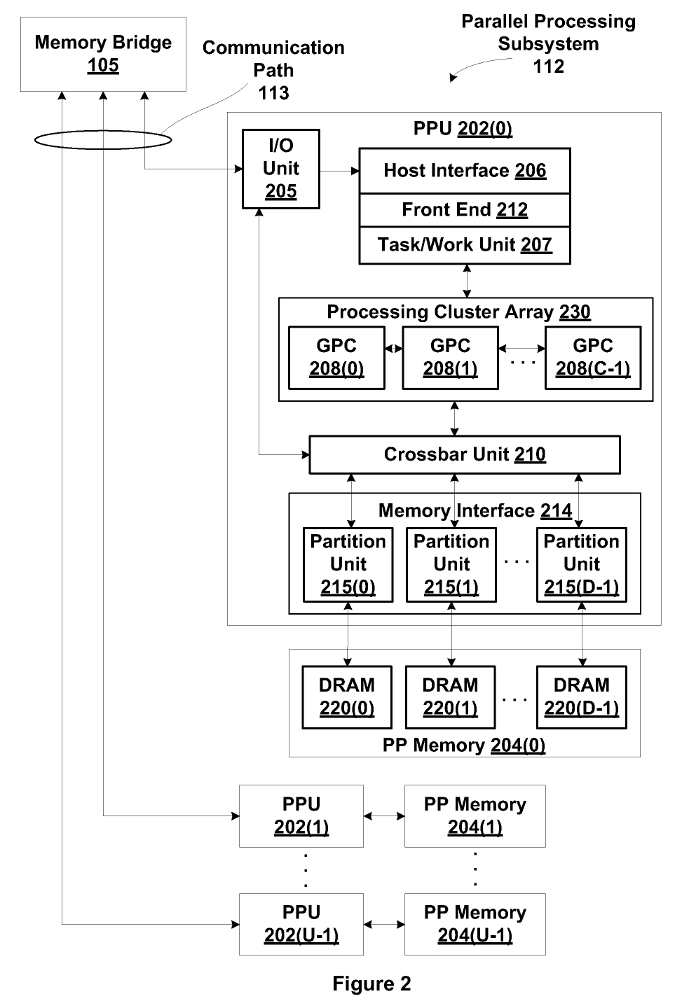

FIG. 2 illustrates a parallel processing subsystem 112, according to one embodiment of the present invention. As shown, parallel processing subsystem 112 includes one or more parallel processing units (PPUs) 202, each of which is coupled to a local parallel processing (PP) memory 204. In general, a parallel processing subsystem includes a number U of PPUs, where U≧1. (Herein, multiple instances of like objects are denoted with reference numbers identifying the object and parenthetical numbers identifying the instance where needed.) PPUs 202 and parallel processing memories 204 may be implemented using one or more integrated circuit devices, such as programmable processors, application specific integrated circuits (ASICs), memory devices, or in any other technically feasible fashion.

Referring again to FIG. 1 as well as FIG. 2, in some embodiments, some or all of PPUs 202 in parallel processing subsystem 112 are graphics processors with rendering pipelines that can be configured to perform various operations related to generating pixel data from graphics data (e.g., video frames and/or pixel blocks) supplied by CPU 102 and/or system memory 104 via memory bridge 105 and the second communication path 113, interacting with local parallel processing memory 204 (which can be used as graphics memory including, e.g., a conventional frame buffer) to store and update pixel data, delivering pixel data to display device 110, and the like. In some embodiments, parallel processing subsystem 112 may include one or more PPUs 202 that operate as graphics processors and one or more other PPUs 202 that are used for general-purpose computations. The PPUs may be identical or different, and each PPU may have a dedicated parallel processing memory device(s) or no dedicated parallel processing memory device(s). One or more PPUs 202 in parallel processing subsystem 112 may output data to display device 110 or each PPU 202 in parallel processing subsystem 112 may output data to one or more display devices 110.

In operation, CPU 102 is the master processor of computer system 100, controlling and coordinating operations of other system components. In particular, CPU 102 issues commands that control the operation of PPUs 202. In some embodiments, CPU 102 writes a stream of commands for each PPU 202 to a data structure (not explicitly shown in either FIG. 1 or FIG. 2) that may be located in system memory 104, parallel processing memory 204, or another storage location accessible to both CPU 102 and PPU 202. A pointer to each data structure is written to a pushbuffer to initiate processing of the stream of commands in the data structure. The PPU 202 reads command streams from one or more pushbuffers and then executes commands asynchronously relative to the operation of CPU 102. Execution priorities may be specified for each pushbuffer by an application program via the device driver 103 to control scheduling of the different pushbuffers.

Referring back now to FIG. 2 as well as FIG. 1, each PPU 202 includes an I/O (input/output) unit 205 that communicates with the rest of computer system 100 via communication path 113, which connects to memory bridge 105 (or, in one alternative embodiment, directly to CPU 102). The connection of PPU 202 to the rest of computer system 100 may also be varied. In some embodiments, parallel processing subsystem 112 is implemented as an add-in card that can be inserted into an expansion slot of computer system 100. In other embodiments, a PPU 202 can be integrated on a single chip with a bus bridge, such as memory bridge 105 or I/O bridge 107. In still other embodiments, some or all elements of PPU 202 may be integrated on a single chip with CPU 102.

In one embodiment, communication path 113 is a PCI Express link, in which dedicated lanes are allocated to each PPU 202, as is known in the art. Other communication paths may also be used. An I/O unit 205 generates packets (or other signals) for transmission on communication path 113 and also receives all incoming packets (or other signals) from communication path 113, directing the incoming packets to appropriate components of PPU 202. For example, commands related to processing tasks may be directed to a host interface 206, while commands related to memory operations (e.g., reading from or writing to parallel processing memory 204) may be directed to a memory crossbar unit 210. Host interface 206 reads each pushbuffer and outputs the command stream stored in the pushbuffer to a front end 212.

Each PPU 202 advantageously implements a highly parallel processing architecture. As shown in detail, PPU 202(0) includes a processing cluster array 230 that includes a number C of general processing clusters (GPCs) 208, where C≧1. Each GPC 208 is capable of executing a large number (e.g., hundreds or thousands) of threads concurrently, where each thread is an instance of a program. In various applications, different GPCs 208 may be allocated for processing different types of programs or for performing different types of computations. The allocation of GPCs 208 may vary dependent on the workload arising for each type of program or computation.

GPCs 208 receive processing tasks to be executed from a work distribution unit within a task/work unit 207. The work distribution unit receives pointers to processing tasks that are encoded as task metadata (TMD) and stored in memory. The pointers to TMDs are included in the command stream that is stored as a pushbuffer and received by the front end unit 212 from the host interface 206. Processing tasks that may be encoded as TMDs include indices of data to be processed, as well as state parameters and commands defining how the data is to be processed (e.g., what program is to be executed). The task/work unit 207 receives tasks from the front end 212 and ensures that GPCs 208 are configured to a valid state before the processing specified by each one of the TMDs is initiated. A priority may be specified for each TMD that is used to schedule execution of the processing task. Optionally, the TMD can include a parameter that controls whether the TMD is added to the head or the tail for a list of processing tasks (or list of pointers to the processing tasks), thereby providing another level of control over priority.

Memory interface 214 includes a number D of partition units 215 that are each directly coupled to a portion of parallel processing memory 204, where D≧1. As shown, the number of partition units 215 generally equals the number of dynamic random access memory (DRAM) 220. In other embodiments, the number of partition units 215 may not equal the number of memory devices. Persons of ordinary skill in the art will appreciate that DRAM 220 may be replaced with other suitable storage devices and can be of generally conventional design. A detailed description is therefore omitted. Render targets, such as frame buffers or texture maps may be stored across DRAMs 220, allowing partition units 215 to write portions of each render target in parallel to efficiently use the available bandwidth of parallel processing memory 204.

Any one of GPCs 208 may process data to be written to any of the DRAMs 220 within parallel processing memory 204. Crossbar unit 210 is configured to route the output of each GPC 208 to the input of any partition unit 215 or to another GPC 208 for further processing. GPCs 208 communicate with memory interface 214 through crossbar unit 210 to read from or write to various external memory devices. In one embodiment, crossbar unit 210 has a connection to memory interface 214 to communicate with I/O unit 205, as well as a connection to local parallel processing memory 204, thereby enabling the processing cores within the different GPCs 208 to communicate with system memory 104 or other memory that is not local to PPU 202. In the embodiment shown in FIG. 2, crossbar unit 210 is directly connected with I/O unit 205. Crossbar unit 210 may use virtual channels to separate traffic streams between the GPCs 208 and partition units 215.

Again, GPCs 208 can be programmed to execute processing tasks relating to a wide variety of applications, including but not limited to, linear and nonlinear data transforms, filtering of video and/or audio data, modeling operations (e.g., applying laws of physics to determine position, velocity and other attributes of objects), image rendering operations (e.g., tessellation shader, vertex shader, geometry shader, and/or pixel shader programs), and so on. PPUs 202 may transfer data from system memory 104 and/or local parallel processing memories 204 into internal (on-chip) memory, process the data, and write result data back to system memory 104 and/or local parallel processing memories 204, where such data can be accessed by other system components, including CPU 102 or another parallel processing subsystem 112.

A PPU 202 may be provided with any amount of local parallel processing memory 204, including no local memory, and may use local memory and system memory in any combination. For instance, a PPU 202 can be a graphics processor in a unified memory architecture (UMA) embodiment. In such embodiments, little or no dedicated graphics (parallel processing) memory would be provided, and PPU 202 would use system memory 104 exclusively or almost exclusively. In UMA embodiments, a PPU 202 may be integrated into a bridge chip or processor chip or provided as a discrete chip with a high-speed link (e.g., PCI Express) connecting the PPU 202 to system memory via a bridge chip or other communication means.

As noted above, any number of PPUs 202 can be included in a parallel processing subsystem 112. For instance, multiple PPUs 202 can be provided on a single add-in card, or multiple add-in cards can be connected to communication path 113, or one or more of PPUs 202 can be integrated into a bridge chip. PPUs 202 in a multi-PPU system may be identical to or different from one another. For instance, different PPUs 202 might have different numbers of processing cores, different amounts of local parallel processing memory, and so on. Where multiple PPUs 202 are present, those PPUs may be operated in parallel to process data at a higher throughput than is possible with a single PPU 202. Systems incorporating one or more PPUs 202 may be implemented in a variety of configurations and form factors, including desktop, laptop, or handheld personal computers, smart phones, servers, workstations, game consoles, embedded systems, and the like.

### Detecting and Measuring Video Scene Transitions

Detecting and measuring video scene transitions permits extraction of useful information for the purposes of indexing and retrieval, performing scene analysis, and increasing video compression efficiency. One category of scene transitions includes dissolve transitions. In dissolve transitions, proportions of two of more input images are combined such that the input images appear to merge into an output image. For example, a dissolve transition from image A to image B may be performed by varying the contribution of image A from 100% to 0% while simultaneously varying the contribution of image B from 0% to 100%. When image A is a solid color, this transition is referred to as a fade in transition; when image B is a solid color, this transition is referred to as a fade out transition. Mathematically, the fade in and fade out transitions can be modeled as shown below in Equations 1 and 2, respectively, where C is a solid color, Sₙ(i,j) is the resulting video signal, fₙ(i,j) is image A, gₙ(i,j) is image B, L₁ is the duration of sequence A, F is the duration of the transition sequence, and L₂ is the duration of the total sequence.

$$\begin{matrix}{S}_{n} ( i , j ) = \{ \begin{matrix}{f}_{n} ( i , j ) , & 0 \leq n \leq {L}_{1} \\ [ 1 - ( \frac{n - {L}_{1}}{F} ) ] C + ( \frac{n - {L}_{1}}{F} ) {g}_{n} ( i , j ) , & {L}_{1} \leq n \leq ( {L}_{1} + F ) \\ {g}_{n} ( i , j ) , & ( {L}_{1} + F ) < n \leq {L}_{2}\end{matrix} \} & ( Eq . 1 ) \\ {S}_{n} ( i , j ) = \{ \begin{matrix}{f}_{n} ( i , j ) , & 0 \leq n \leq {L}_{1} \\ [ 1 - ( \frac{n - {L}_{1}}{F} ) ] {f}_{n} ( i , j ) + ( \frac{n - {L}_{1}}{F} ) C , & {L}_{1} \leq n \leq ( {L}_{1} + F ) \\ {g}_{n} ( i , j ) , & ( {L}_{1} + F ) < n \leq {L}_{2}\end{matrix} \} & ( Eq . 2 )\end{matrix}$$

One way of detecting fade in and fade out transitions is by constructing and analyzing histograms. As is understood by those of ordinary skill in the art, a histogram may be constructed by sampling each pixel in an image and determining how many pixels occupy each intensity value (e.g., luminance, RGB brightness, etc.). For example, assuming an image has a size of (M, N) pixels and each pixel has an 8-bit luminance value, then each pixel's value lies in the range of 0-255. The corresponding histogram then would include 256 possible values and M*N total votes. After constructing a histogram for each relevant frame in the video stream, each histogram then may be analyzed to determine minimum and maximum intensity values. For example, the histogram described above may be analyzed to determine the minimum and maximum luminance values (0-255) of the M*N pixels. Next, a luminance range may be calculated for each video frame by subtracting each minimum luminance value from the corresponding maximum luminance value. Finally, luminance range values for consecutive video frames may be compared to determine whether the range is increasing or decreasing and, thus, whether a fade in or fade out transition is occurring.

Although the approach described above may be capable of detecting a fade in or fade out transition, the approach has several drawbacks. First, the approach is not time-efficient, since every pixel in each video frame is sampled. Second, because the approach relies on detecting the luminance ranges in consecutive video frames, image noise which exceeds the minimum or maximum luminance value may lead to inaccurate detection of scene transitions. Third, the approach typically relies on analysis of the entire duration of a scene transition. For example, detection of a fade in transition may require detection of a condition where the luminance range is substantially equal to zero (i.e., every pixel in the video frame is the same color). Finally, the approach does not enable quantification of fade in or fade out parameters (e.g., scale and shift values).

In an improved technique for detecting scene transitions (e.g., fade in and fade out transitions), one or more pixel groupings (e.g., pixel blocks, macroblocks, etc.) in each video frame may be sampled and analyzed to detect changes in the intensity of pixel groupings between two or more consecutive or non-consecutive video frames. Changes in intensity may be tracked to determine whether a trend exists across a plurality of video frames and, thus, whether a scene transition is likely occurring. Finally, the type of scene transition (e.g., fade in or fade out) may be determined by calculating and analyzing variations and trends of the pixel intensity ranges of each pixel grouping and/or video frame.

From Equations 1 and 2, shown above, the behavior of each pixel may be modeled for fade in and fade out transitions. In fade in transitions, as the transition proceeds, each pixel Sₙ(i,j) transitions from a color value C to a coordinate pixel value gₙ(i,j). In fade out transitions, as the transition proceeds, each pixel Sₙ(i,j) transitions from a coordinate pixel value fₙ(i,j) to a color value C. Accordingly, based on Equations 1 and 2, the fading period of the fade in and fade out transitions can be mathematically modeled by Equations 3 and 4, respectively.

$$\begin{matrix}Δ S ( i , j ) = {S}_{n + 1} ( i , j ) - {S}_{n} ( i , j ) = - \frac{1}{F} C + \frac{1}{F} {g}_{n} ( i , j ) & ( Eq . 3 ) \\ Δ S ( i , j ) = {S}_{n + 1} ( i , j ) - {S}_{n} ( i , j ) = - \frac{1}{F} C - \frac{1}{F} {f}_{n} ( i , j ) & ( Eq . 4 )\end{matrix}$$

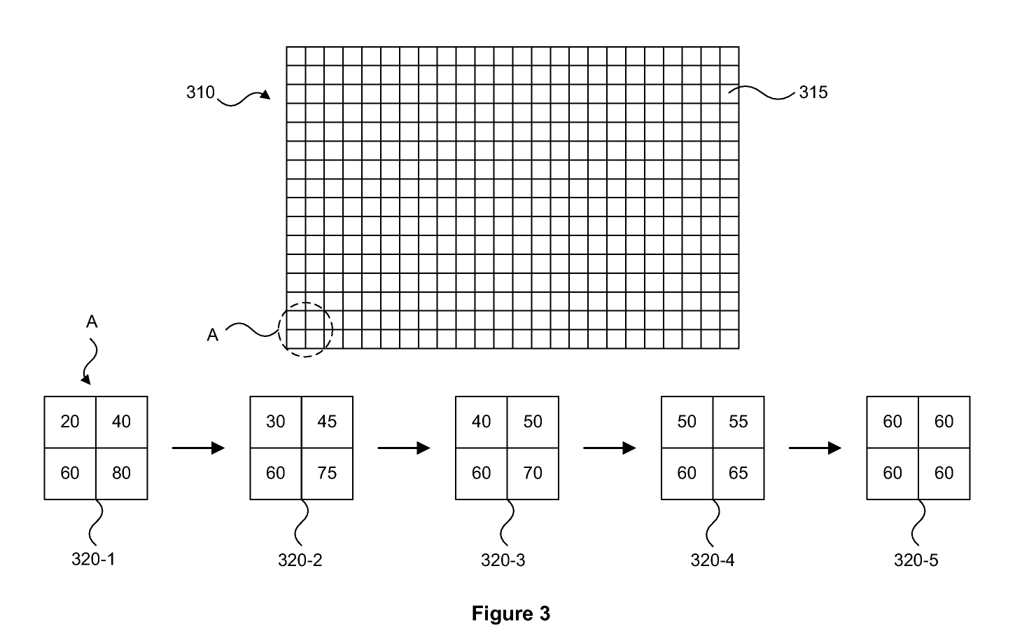

FIG. 3 illustrates a sequence of pixel blocks during a fade out scene transition, according to one embodiment of the present invention. Each exemplary pixel block 320-1 through 320-5 illustrates a set of pixels 315 located at location A in five sequential video frames. More specifically, pixel block 320-1 corresponds to a set of pixels 315 at location A in a first video frame 310, pixel block 320-2 corresponds to a set of pixels 315 at location A in a second video frame 310, pixel block 320-3 corresponds to a set of pixels 315 at location A in a third video frame 310, and so on. In the exemplary embodiment, pixel blocks 320-1 through 320-5 (collectively “320”) correspond to five consecutive video frames 310. Each pixel 315 may include a pixel intensity value (e.g., a luminance value). For example, in the exemplary embodiment, the pixels 315 in pixel block 320-1 include luminance values of 20, 40, 60, and 80.

As shown in FIG. 3, during a fade out transition, the luminance values of the pixels 315 in each pixel block 320 may converge to a single color value. Thus, after four consecutive video frames, the initial pixel values 20, 40, 60, 80 of pixel block 320-1 transition to the final pixel values 60, 60, 60, 60 of pixel block 320-5. Each pixel 315 in pixel blocks 320 changes independently. That is, the sign and/or magnitude of the change to the luminance value of each pixel 315 from video frame to video frame may be different. However, the rate of change of each individual pixel 315 may be continuous during the fading period.

From FIG. 3, we can ascertain three types of trends. In FIG. 3, the luminance of the pixels 315 having starting values of 20 and 40 increases with each video frame such that the destination value is larger than the starting value. Consequently, this trend may be referred to as “INCREASE.” The luminance of the pixel 315 having a starting value of 80 decreases with each video frame such that the destination value is smaller than the starting value. Consequently, this trend may be referred to as “DECREASE.” Finally, the luminance of the pixel 315 having a starting value of 60 remains constant such that the destination value is the same as the starting value. This trend may be referred to as “IGNORE.”

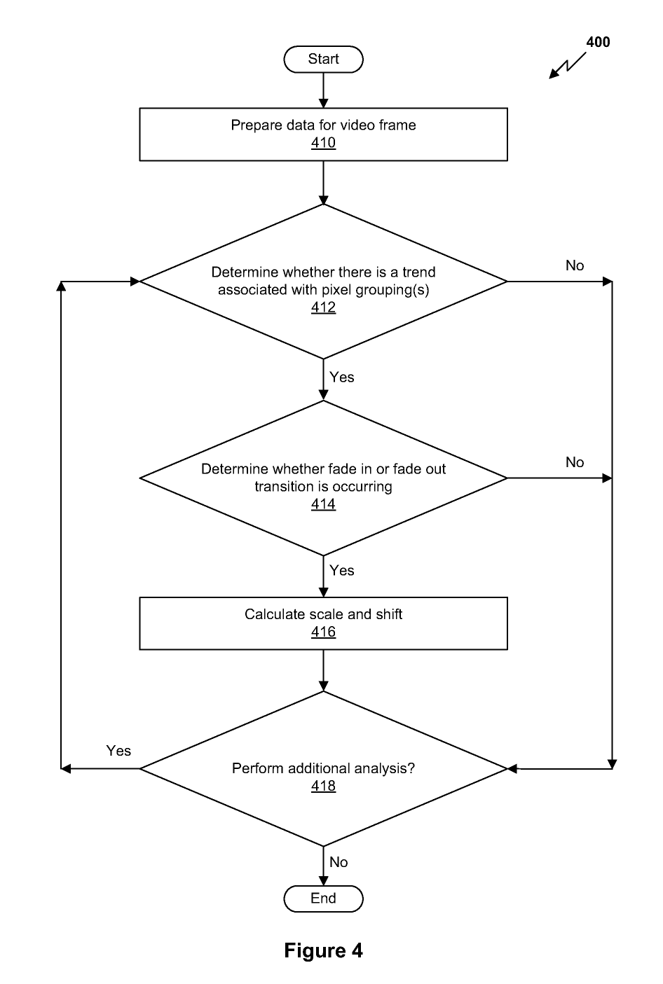

Although each pixel 315 in the exemplary pixel blocks 320 exhibits a continuous trend during the fading period, in real world applications, image noise and/or movement may complicate the detection of pixel trends. As a result, changes in the intensity of a single pixel may not accurately reflect whether a scene transition is taking place. Accordingly, groupings of pixels may be analyzed as a whole to detect whether a trend exists. For example, the mean of a pixel grouping may be less susceptible to image noise and/or movement, but may still enable a trend to be detected during a scene transition. Pixel groupings of any size may be selected. In an exemplary embodiment, the pixel groupings may include several pixel blocks (e.g., 8×8 pixel blocks, 16×16 pixel blocks, or larger). Once pixel groupings are selected and fetched from one or more video frames, the pixel groupings may be processed to determine whether a scene transition is occurring, what type of scene transition is occurring, and the parameters of the scene transition, as described in further detail in FIGS. 4-7.

FIG. 4 is a flow diagram of methods steps for detecting and measuring a video scene transition, according to one embodiment of the present invention. Although the method steps are described in conjunction with FIGS. 1-3, persons skilled in the art will understand that any system configured to perform the method steps, in any order, falls within the scope of the present invention.

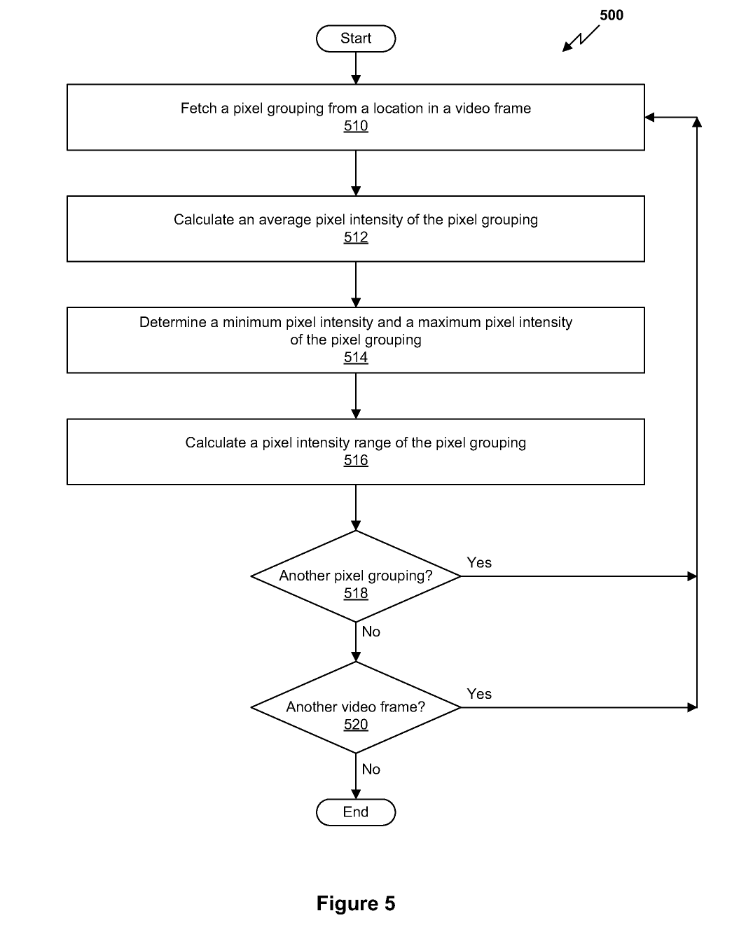

The method begins at step 410, where data for a video frame is prepared. An exemplary method for the preparation of data for each video frame is illustrated in FIG. 5. As shown in FIG. 5, at the beginning of each video frame, one or more pixel groupings (e.g., one or more pixel blocks) are fetched at step 510. In order to detect trends between sequential video frames, pixel groupings may be fetched from the same or similar location(s) in each video frame. For example, as shown in FIG. 3, each pixel block 320 was acquired from the same location (A) in each of the five video frames. Moreover, it is contemplated that the location in a video frame from which a pixel grouping is fetched for a particular video frame may be varied, for example, in order to compensate for camera movement and/or movement of an object in the video frame.

Next, at steps 512-516, the pixel block(s) are analyzed to determine and/or calculate pixel information. For instance, at step 512, the mean value of all of the pixels in one or more pixel blocks may be calculated. At step 514, the minimum intensity value in the pixel block(s) and the maximum intensity value in the pixel block(s) are determined. At step 516, the intensity range of the pixel block(s) may be calculated as the difference between the maximum intensity value and the minimum intensity value in a pixel block. Finally, at steps 518 and 520, if processing of additional pixel groupings or video frames is desired, the method may return to step 510.

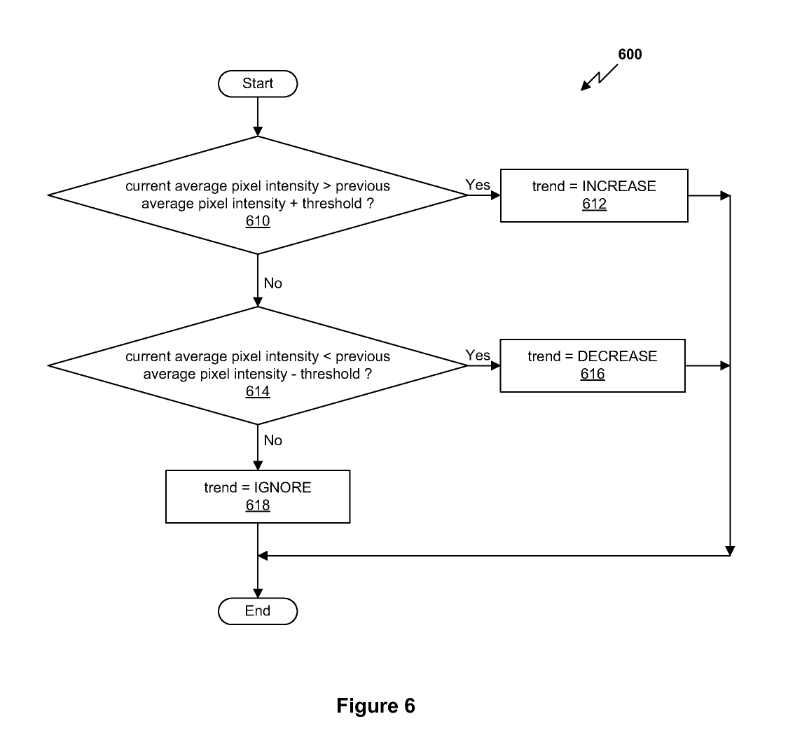

Once data for one or more video frames is prepared, the trend of a plurality of pixel groupings may be determined at step 412. An exemplary method for determining the trend of a plurality of pixel groupings is illustrated in FIG. 6. As shown in FIG. 6, a trend may be determined by comparing the average pixel intensities of pixel groupings fetched from the same (or substantially the same) location in a first and second video frame. For example, at steps 610 and 614, the average pixel intensity of a pixel grouping in a current video frame is compared to the average pixel intensity of a pixel grouping in a previous video frame. Specifically, at step 610, if the average pixel intensity of a pixel grouping in the current video frame is greater than the average pixel intensity of a pixel grouping in the previous video frame plus a threshold value, then the trend is identified as INCREASE (i.e., increasing average intensity) at step 612. At step 614, if the average pixel intensity of a pixel grouping in the current video frame is less than the average pixel intensity of a pixel grouping in the previous video frame minus a threshold value, then the trend is identified as DECREASE (i.e., decreasing average intensity) at step 616. If neither of these conditions is met, then the trend is identified as IGNORE (e.g., insignificant or indeterminate) at step 618.

The threshold value specified in steps 610 and 614 may be used to compensate for a margin of error, for example, due to image noise, and/or to reduce sensitivity to minor, insignificant fluctuations in average intensity. Once the trend for a plurality of pixel groupings is determined, it may be associated with one or more pixel groupings and stored as pixel data 132 in system memory 104.

Once multiple trends (e.g., DECREASE, INCREASE, IGNORE) have been acquired for a set of pixel groupings which correspond to the same location in a series of video frames, the trends may be compared to determine whether a scene transition is occurring. For example, if a fade in or fade out transition is occurring, pixel groupings taken from the same location in sequential (consecutive or non-consecutive) video frames should exhibit the same or substantially the same trend.

Table I, illustrated below, may be used to compare the pixel grouping trends associated with a particular location in a sequence of video frames to determine whether the trends are a match (MATCH), not a match (NOT MATCH), or neither a MATCH nor a NOT MATCH (NORMATCH).

TABLE I

| Current picture | Last picture | Trend status |
|---|---|---|
| INCREASE | INCREASE | MATCH |
| | DECREASE | NOTMATCH |
| | IGNORE | NORMATCH |
| DECREASE | INCREASE | NOTMATCH |
| | DECREASE | MATCH |
| | IGNORE | NORMATCH |
| IGNORE | INCREASE | NORMATCH |
| | DECREASE | NORMATCH |
| | IGNORE | MATCH |

The result of each comparison may be stored as pixel data 132 in system memory 104. Additionally, a counter may be incremented each time a comparison is made. For example, a first counter matchNum may be incremented when a match exists (MATCH), a second counter notMatchNum may be incremented when a match does not exist (NOT MATCH), and a third counter norMatchNum may be incremented when neither a MATCH nor a NOT MATCH condition is met (NORMATCH). One or more of the counters then may be used to determine whether a fading scene transition is occurring. An exemplary set of conditions for determining whether a fading scene transition may be occurring is provided below. A threshold value may be provided to compensate for image noise and slight movement in the video frame. In the exemplary embodiment, assuming there are 16 comparison results, the threshold value may be set to 6.

IF (notMatchNum > 0), THEN no fading
ELSE IF (norMatchNum > threshold), THEN no fading
ELSE may be fading, proceed to step 414

If either of the “no fading” conditions shown above is met, the method may proceed to step 418, at which point additional pixel groupings and/or video frames may be analyzed. If neither of the “no fading” conditions shown above is met, the method may proceed to step 414, where the intensity ranges of the pixel groupings may be analyzed to confirm that a scene transition is occurring and/or to determine the type of scene transition.

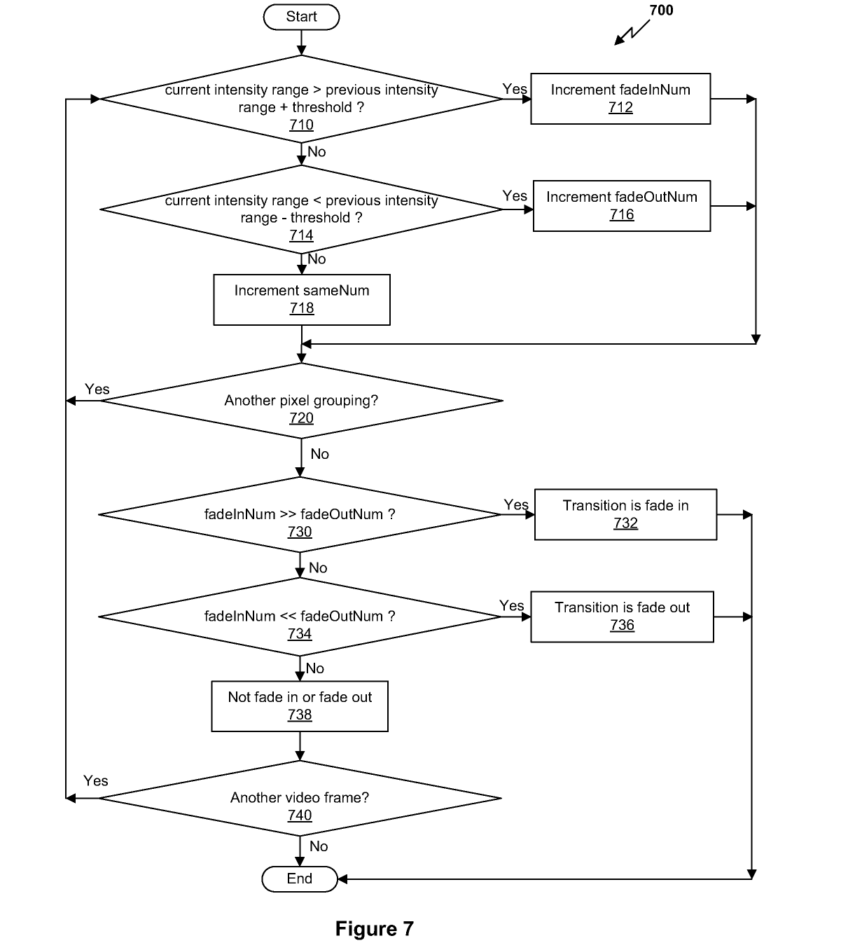

An exemplary method of confirming that a scene transition is occurring and/or determining the type of scene transition is illustrated in FIG. 7. As shown in FIG. 7, the intensity range of one or more pixel blocks may be used to determine whether the fading period of a scene transition is a fade in transition or a fade out transition. More specifically, during a fade in transition the intensity range of the pixel block will increase across sequential video frames, while during a fade out transition, the intensity range will decrease across sequential video frames.

The method of FIG. 7 begins at steps 710 and 714, where the intensity range of a pixel grouping in a current video frame is compared to the intensity range of a pixel grouping in a previous video frame. Specifically, at step 710, if the intensity range of a pixel grouping in the current video frame is greater than the intensity range of a pixel grouping in the previous video frame plus a threshold value, then a counter fadeInNum is incremented at step 712. At step 714, if the intensity range of a pixel grouping in the current video frame is less than the intensity range of a pixel grouping in the previous video frame minus a threshold value, then a counter fadeOutNum is incremented at step 616. Assuming that each pixel has an 8-bit intensity value, an exemplary threshold value may be 2. If neither of these conditions is met, then a counter sameNum is incremented at step 618.

Steps 710 and 714 may be repeated multiple times for additional pixel groupings, as specified in step 720. Once the intensity ranges associated with a desired number of pixel groupings have been compared, the counters may be compared at steps 730 and 734. Specifically, at step 730, if the fadeInNum counter is significantly greater than the fadeOutNum counter, then the transition type is specified as fade in at step 732. At step 734, if the fadeInNum counter is significantly less than the fadeOutNum counter, then the transition type is specified as fade out at step 736. If neither of the above conditions is met, the transition type is specified as neither fade in nor fade out and/or it may be determined that a scene transition is not occurring at step 738. A variety of different criteria may be used to determine whether the fadeInNum counter is ‘significantly’ greater than or ‘significantly’ less than the fadeOutNum counter. Exemplary criteria include, without limitation, whether |fadeInNum−fadeOutNum| is greater than a threshold value and/or a percentage difference between the counter values. Finally, at step 740, one or more additional video frames may be processed.

Although not illustrated in FIG. 7, an additional determination may be made with respect to the sameNum counter to detect a fading transition between two solid colored images. In such a case, the intensity range of each image may be the same (or substantially the same if image noise is present). Thus, it may be determined that a fading transition between two solid colors is occurring when the fadeInNum and fadeOutNum counters are equal zero (or substantially equal to zero if image noise is present).

Finally, at step 416, the scene transition may be measured. In the exemplary embodiment described herein, measurement of the scene transition may include calculating a scale value and a shift value for each video frame (or for a series of video frames), which may later be used by a video codec (e.g., H.264, H.265, VC-1, etc.) when compressing/encoding the video stream. From Equations 3 and 4, we can define the fading which occurs during a fade in or fade out transition according to Equation 5, provided below. In addition, the scale value and a shift value of Equation 5 may be calculated for each pixel block in a video frame according to Equations 6 and 7, provided below, where min1 and max1 are the minimum and maximum pixel intensities for a pixel grouping in a current video frame, and min2 and max2 are the minimum and maximum pixel intensities for a pixel grouping in the next video frame.

Sₙ₊₁(i,j)=scale*Sₙ(i,j)+shift (Eq. 5)

min2=scale*min1+shift (Eq. 6)

max2=scale*max1+shift (Eq. 7)

The scale value may be in the range of (0,+∞). The scale may be larger than 1 for a fade in transition and equal to or less than 1 for a fade out transition. The shift value may be an offset and may be either positive or negative. Optionally, the scale and shift values may be normalized or scaled such that a division operation is not required to determine whether a fade in or fade out transition is occurring. For example, the min1, max1, min2, and max2 values may be multiplied by 64 (or 128, etc.) such that it may be determined that a fade in transition is occurring when the scale is larger than 64 and a fade out transition is occurring when the scale is less than or equal to 64.

The calculated scale and shift values may be verified by calculating a predicted average pixel intensity avr2 for one or more pixel blocks according to Equation 8, provided below.

avr2=scale*avr1+shift (Eq. 8)

The calculated predicted average then may be compared to the actual average pixel intensities of one or more pixel groupings according to the exemplary conditions provided below.

IF ( |predAvr − currAvr| <= |lastAvr − currAvr| ) the prediction matches
ELSE the prediction does not match

If the predicted average intensity values calculated with the scale and shift values match a threshold number or threshold percentage of actual average pixel intensities, then the scale and shift values may be added to a listing of candidates. Further each value |predAvr−currAvr| associated with a particular set of scale and shift values may be summed up and stored as a score for the candidate scale and shift values. Other potential candidates used to determine scale and shift values may include (1) the best candidate (e.g., determined by a score) from a predetermined number of pixel blocks (e.g., 4 pixel blocks), (2) the average value of multiple candidates, (3) the previous video frame's scale and shift values, or (4) the average value of (2) and (3).

In an exemplary implementation of the techniques illustrated in FIGS. 4-7, a 720×576 video stream, containing a fade in transition, fade out transition, slight movement, and background noise, was processed via two approaches. The first approach analyzed nine 16×16 pixel blocks, while the second approach analyzed four 16×16 pixel blocks. Algorithm efficiency was then evaluated by applying the sum of absolute differences (SAD) technique to image A and image B, pixel to pixel, according to Equation 9, provided below. The results are illustrated in Table II, shown below.

$$SAD saving = \frac{\begin{matrix}SAD ( current picture , last picture ) - \\ SAD ( current picture , prediction picture )\end{matrix}}{SAD ( current picture , last picture )} \qquad ( Eq . 9 )$$

TABLE II

| | four 16 × 16 | | | nine 16 × 16 | | | |
|---|---|---|---|---|---|---|---|
| | pixel blocks | | | pixel blocks | | | |
| | | | SAD | | | SAD | Fading |
| picture | scale | shift | saving | scale | shift | saving | type |
| 55 | 61 | 1 | 32.1% | 60 | 1 | 39.5% | fade-out |
| 56 | 60 | 1 | 42.3% | 60 | 1 | 42.3% | fade-out |
| 57 | 60 | 1 | 42.0% | 59 | 1 | 41.9% | fade-out |
| 58 | 60 | 1 | 42.7% | 59 | 1 | 47.6% | fade-out |
| 59 | 59 | 1 | 49.4% | 59 | 1 | 49.4% | fade-out |
| 60 | 59 | 1 | 49.6% | 58 | 2 | 49.6% | fade-out |
| 61 | 59 | 1 | 50.2% | 57 | 2 | 55.6% | fade-out |
| 62 | 56 | 2 | 58.3% | 57 | 2 | 56.8% | fade-out |
| 63 | 56 | 2 | 57.9% | 57 | 1 | 55.0% | fade-out |
| 64 | 56 | 2 | 60.5% | 55 | 2 | 65.7% | fade-out |
| 65 | 52 | 3 | 69.2% | 55 | 2 | 65.5% | fade-out |
| 66 | 48 | 4 | 65.3% | 50 | 3 | 65.6% | fade-out |
| 67 | 51 | 3 | 71.1% | 48 | 4 | 75.2% | fade-out |
| 68 | 40 | 6 | 79.2% | 42 | 5 | 77.4% | fade-out |
| 69 | 36 | 7 | 77.4% | 34 | 7 | 89.6% | fade-out |
| 70 | 36 | 7 | 41.2% | 34 | 7 | 58.8% | fade-out |
| . . . | | | | | | | |
| 88 | 85 | −5 | 74.8% | 84 | −5 | 75.9% | fade-in |
| 89 | 78 | −4 | 69.6% | 77 | −3 | 68.4% | fade-in |
| 90 | 78 | −4 | 73.0% | 77 | −3 | 74.3% | fade-in |
| 91 | 78 | −4 | 60.8% | 73 | −2 | 70.1% | fade-in |
| 92 | 73 | −2 | 65.2% | 72 | −2 | 67.4% | fade-in |
| 93 | 73 | −2 | 57.9% | 72 | −2 | 66.1% | fade-in |
| 94 | 73 | −2 | 44.4% | 70 | −2 | 58.3% | fade-in |
| 95 | 69 | −1 | 58.0% | 71 | −2 | 60.5% | fade-in |
| 96 | 69 | −1 | 59.5% | 71 | −2 | 53.2% | fade-in |
| 97 | 69 | −1 | 60.1% | 69 | −1 | 60.1% | fade-in |
| 98 | 69 | −1 | 56.5% | 69 | −1 | 56.5% | fade-in |
| 99 | 69 | −1 | 53.2% | 69 | −2 | 55.4% | fade-in |
| 100 | 69 | −1 | 40.6% | 69 | −2 | 47.4% | fade-in |
| 101 | 68 | −1 | 53.0% | 68 | −1 | 53.0% | fade-in |

In sum, pixel data may be fetched from one or more video frames in a video stream and analyzed to determine pixel intensity characteristics. The pixel intensity characteristics associated with pixel groupings in sequential video frames then may be compared to determine whether a trend exists and, thus, whether a scene transition is likely occurring. The type of scene transition may be determined by comparing pixel intensity ranges of pixel groupings in sequential video frames. Finally, the scene transition may be measured and quantified, and the resulting parameters may be used to index and/or compress the video stream.

One advantage of the disclosed technique is that scene transitions may be detected and measured, and their parameters provided to a video codec, in order to improve indexing, retrieval, and compression efficiency. Additionally, by analyzing only portions (e.g., pixel groupings) of each video frame, and not entire video frames, the processing requirements associated with video stream encoding may be reduced.

One embodiment of the invention may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive, flash memory, ROM chips or any type of solid-state non-volatile semiconductor memory) on which information is permanently stored; and (ii) writable storage media (e.g., floppy disks within a diskette drive or hard-disk drive or any type of solid-state random-access semiconductor memory) on which alterable information is stored.

The invention has been described above with reference to specific embodiments. Persons of ordinary skill in the art, however, will understand that various modifications and changes may be made thereto without departing from the broader spirit and scope of the invention as set forth in the appended claims. The foregoing description and drawings are, accordingly, to be regarded in an illustrative rather than a restrictive sense.

Therefore, the scope of embodiments of the present invention is set forth in the claims that follow.

What is claimed:

1. A method of detecting a video transition, the method comprising:
calculating a first average pixel intensity for each pixel grouping included in a first plurality of pixel groupings fetched from a plurality of locations in a first video frame;
calculating a second average pixel intensity for each pixel grouping included in a second plurality of pixel groupings fetched from the plurality of locations in a second video frame;
calculating a third average pixel intensity for each pixel grouping included in a third plurality of pixel groupings fetched from the plurality of locations in a third video frame;
for each location in the plurality of locations:
comparing the first average pixel intensity to the corresponding second average pixel intensity to identify a first trend;
comparing the second average pixel intensity to the corresponding third average pixel intensity to identify a second trend; and
comparing the first trend to the second trend to determine whether a match exits; and
determining that a video transition is occurring based on a number of matches across the plurality of locations.

2. The method of claim 1, wherein each of the first trend and second trend comprises an increasing average pixel intensity, a decreasing average pixel intensity, or a substantially constant average pixel intensity.

3. The method of claim 1, further comprising:
at least one of:
incrementing a first counter if a match exists;
incrementing a second counter if a match does not exist; and
determining that the video transition is occurring by analyzing at least one of the first counter and the second counter.

4. The method of claim 1, further comprising:
for each pixel grouping in the first plurality of pixel groupings, subtracting a first minimum pixel intensity from a first maximum pixel intensity to calculate a first intensity range;
for each pixel grouping in the second plurality of pixel groupings, subtracting a second minimum pixel intensity from a second maximum pixel intensity to calculate a second intensity range; and
comparing each first intensity range to a corresponding second intensity range to determine that the video transition is a fade in transition or a fade out transition.

5. The method of claim 4, wherein comparing each first intensity range to the corresponding second intensity range comprises:
incrementing a third counter if the second intensity range is greater than the first intensity range;
incrementing a fourth counter if the second intensity range is less than the first intensity range; and
comparing the third counter to the fourth counter to determine that the video transition is a fade in transition or a fade out transition.

6. The method of claim 4, further comprising calculating a scale value and a shift value of the video transition with the first minimum pixel intensity, second minimum pixel intensity, first maximum pixel intensity, and second maximum pixel intensity.

7. The method of claim 6, further comprising:
calculating a predicted average pixel intensity with the scale value and the shift value; and
comparing the predicted average pixel intensity to a first average pixel intensity for a pixel grouping included in the first plurality of pixel groupings.

8. The method of claim 1, wherein each average pixel intensity included in the first average pixel intensity and the second average pixel intensity comprises an average luminance value.

9. The method of claim 1, wherein each pixel grouping comprises a 16×16 block of pixels.

10. A non-transitory computer-readable storage medium including instructions that, when executed by a processing unit, cause the processing unit to detect a video transition, by performing the steps of:
calculating a first average pixel intensity for each pixel grouping included in a first plurality of pixel groupings fetched from a plurality of locations in a first video frame;
calculating a second average pixel intensity for each pixel grouping included in a second plurality of pixel groupings fetched from the plurality of locations in a second video frame;
calculating a third average pixel intensity for each pixel grouping included in a third plurality of pixel groupings fetched from the plurality of locations in a third video frame;
for each location in the plurality of locations:
comparing the first average pixel intensity to the corresponding second average pixel intensity to identify a first trend;
comparing the second average pixel intensity to the corresponding third average pixel intensity to identify a second trend; and
comparing the first trend to the second trend to determine whether a match exits; and
determining that a video transition is occurring based on a number of matches across the plurality of locations.

11. The non-transitory computer-readable storage medium of claim 10, wherein each of the first trend and second trend comprises an increasing average pixel intensity, a decreasing average pixel intensity, or a substantially constant average pixel intensity.

12. The non-transitory computer-readable storage medium of claim 10, further comprising:
at least one of:
incrementing a first counter if a match exists;
incrementing a second counter if a match does not exist; and
determining that the video transition is occurring by analyzing at least one of the first counter and the second counter.

13. The non-transitory computer-readable storage medium of claim 10, further comprising:
for each pixel grouping in the first plurality of pixel groupings, subtracting a first minimum pixel intensity from a first maximum pixel intensity to calculate a first intensity range;
for each pixel grouping in the second plurality of pixel groupings, subtracting a second minimum pixel intensity from a second maximum pixel intensity to calculate a second intensity range; and
comparing each first intensity range to a corresponding second intensity range to determine that the video transition is a fade in transition or a fade out transition.

14. The non-transitory computer-readable storage medium of claim 13, wherein comparing each first intensity range to the corresponding second intensity range comprises:
incrementing a third counter if the second intensity range is greater than the first intensity range;
incrementing a fourth counter if the second intensity range is less than the first intensity range; and
comparing the third counter to the fourth counter to determine that the video transition is a fade in transition or a fade out transition.

15. The non-transitory computer-readable storage medium of claim 13, further comprising calculating a scale value and a shift value of the video transition with the first minimum pixel intensity, second minimum pixel intensity, first maximum pixel intensity, and second maximum pixel intensity.

16. The non-transitory computer-readable storage medium of claim 15, further comprising:
calculating a predicted average pixel intensity with the scale value and the shift value; and
comparing the predicted average pixel intensity to a first average pixel intensity for a pixel grouping included in the first plurality of pixel groupings.

17. The non-transitory computer-readable storage medium of claim 10, wherein each average pixel intensity included in the first average pixel intensity and the second average pixel intensity comprises an average luminance value.

18. The non-transitory computer-readable storage medium of claim 10, wherein each pixel grouping comprises a 16×16 block of pixels.

19. A computing device, comprising:
a memory; and
a central processing unit coupled to the memory, configured to:
calculate a first average pixel intensity for each pixel grouping included in a first plurality of pixel groupings fetched from a plurality of locations in a first video frame;
calculate a second average pixel intensity for each pixel grouping included in a second plurality of pixel groupings fetched from the plurality of locations in a second video frame;
calculate a third average pixel intensity for each pixel grouping included in a third plurality of pixel groupings fetched from the plurality of locations in a third video frame;
for each location in the plurality of locations:
compare the first average pixel intensity to the corresponding second average pixel intensity to identify a first trend;
compare the second average pixel intensity to the corresponding third average pixel intensity to identify a second trend; and
compare the first trend to the second trend to determine whether a match exits; and
determine that a video transition is occurring based on a number of matches across the plurality of locations.

20. The computing device of claim 19, wherein the central processing unit is further configured to:
for each pixel grouping in the first plurality of pixel groupings, subtract a first minimum pixel intensity from a first maximum pixel intensity to calculate a first intensity range;
for each pixel grouping in the second plurality of pixel groupings, subtract a second minimum pixel intensity from a second maximum pixel intensity to calculate a second intensity range; and
compare each first intensity range to a corresponding second intensity range to determine that the video transition is a fade in transition or a fade out transition.
